(19) United States
(12) Patent Application Publication
(10) Pub. No.: US 2026/0316502 A1
(43) Pub. Date: Oct. 15, 2026

(54) SYSTEMS AND METHODS FOR CONNECTING VEHICLES

(71) Applicant: TGCI LLC, Troy, NY (US)

(72) Inventor: Stephen A. HOYT, Castleton, NY (US)

(73) Assignee: TGCI LLC, Troy, NY (US)

(21) Appl. No.: 19/644,766

(22) Filed: Apr. 10, 2026

Related U.S. Application Data
(60) Provisional application No. 63/786,477, filed on Apr. 10, 2025.

(51) Int. Cl. B60D 1/64; B60D 1/06; B60D 1/36

(52) U.S. Cl. CPC B60D 1/64; B60D 1/06; B60D 1/363; B60L 2200/28

(57) ABSTRACT

A vehicle connection system includes a receiver plate connectable to a first vehicle and locking plates movably connected to the receiver plate. The locking plates have inner surfaces spaced from the receiver plate by a gap. A connecting plate is connectable to a second vehicle and has a thickness less than a dimension of the gap such that the connecting plate is receivable in the gap. The plurality of locking plates is movable toward each other to connect the receiver plate to the connecting plate to connect the first vehicle to the second vehicle when the receiver plate is connected to the first vehicle and the connecting plate is connected to the second vehicle.

### CROSS REFERENCE TO RELATED APPLICATIONS

This application claims priority to U.S. Provisional Application No. 63/786,477 filed on Apr. 10, 2025, entitled “DESCRIPTION OF CONTROL SYSTEMS FOR A SELF-POWERED DRIVERLESS VEHICLE USED TO PROPEL OTHER VEHICLES AND CHARGING OF ELECTRIC VEHICLES AND AN AUTOMATIC CONNECTION/DOCKING DEVICE FOR MULTIPLE CONNECTED USES”, which is incorporated herein by reference in its entirety.

This application is related to co-owned U.S. Application No. ______ (attorney docket no. 5982.001A), filed on the same day as this application, and titled SYSTEMS AND METHODS FOR CONTROLLING A PROPULSION VEHICLE which is incorporated herein by reference in its entirety.

### TECHNICAL FIELD/AREA

This invention relates in general to electrical vehicles, and in particular, to systems and methods for providing supplemental propulsion to a vehicle.

### BACKGROUND OF THE INVENTION

Drivers of vehicles powered by gas or diesel currently have no options for propelling such a vehicle with electric propulsion without an expensive conversion of the vehicle drivetrain. For those with full battery electric vehicles, charge times and access to charging infrastructure remains a concern particularly when a non-local or intercity trip is undertaken. Additionally, electric vehicle range can be dramatically reduced at high speeds or when towing a vehicle such as a trailer or other vehicle. This may increase the need to charge the electric vehicle frequently and cause significant travel delays.

Towed vehicles are traditionally connected to a towing vehicle using a standard towing hitch which may be received in a hitch receiver of a vehicle. The hitch may include a ball extending upon which a towed vehicle ball received may be connected. Such hitch systems are typically used for a towing vehicle to pull a towed vehicle and not for the towed vehicle to push the towing vehicle.

The connection of a towing and towed vehicle via such a hitch and ball hitch received is typically a manual process although some vehicles have systems to aid in an alignment of hitches and ball receivers. Such a manual process may require a person to be outside of a towing vehicle and positioned near to a tow hitch in order to perform tasks such as helping to align the tow vehicle with the towed vehicle, raising or lowering the towed vehicle or trailer, tightening or securing a hitch locking device, fastening safety chains and plug-in lighting or tow braking systems.

A towed vehicle may include its own propulsion as some makers of recreational vehicle trailers have begun developing recreational vehicle trailers with an electric drive system capable of providing propulsion of the trailer so as to offset the reduction in a towing vehicle's range that might otherwise occur in towing.

Thus, a need exists for systems and methods for supplemental propulsion of a passenger vehicle and to increase a range of an electrically powered passenger vehicle.

### SUMMARY OF THE INVENTION

The present invention provides, in a first aspect, a vehicle connection system which includes a receiver plate connectable to a first vehicle and a plurality of locking plates movably connected to the receiver plate. The plurality of locking plates have inner surfaces spaced from the receiver plate by a gap. A connecting plate is connectable to a second vehicle and has a thickness less than a dimension of the gap such that the connecting plate is receivable in the gap when the connecting plate contacts the receiver plate. The plurality of locking plates is movable toward each other to contact an extending portion of the connecting plate to connect the receiver plate to the connecting plate to the receiver plate to connect the first vehicle to the second vehicle when the receiver plate is connected to the first vehicle and the connecting plate is connected to the second vehicle.

The present invention provides, in a second aspect, a method for use in in propelling a vehicle, including contacting a connecting plate connected to a vehicle with a receiver plate connected to a second vehicle. A plurality of locking plates is movably connected to the receiver plate from an outer position toward a center of the receiver plate and toward each other to contact an extending portion of the connecting plate to connect the first vehicle to the second vehicle.

### BRIEF DESCRIPTION OF THE DRAWINGS

The subject matter which is regarded as the invention is particularly pointed out and distinctly claimed in the claims at the conclusion of the specification. The foregoing and other features and advantages of the invention will be readily understood from the following detailed description of the preferred embodiments taken in conjunction with the accompanying drawings in which:

FIG. 1 is a side view of a lead vehicle connected to a propelling vehicle by a vehicle connection system in accordance with the present invention;

FIG. 2 is another example of a lead vehicle connected to a propelling vehicle by a vehicle connection system in accordance with the present invention;

FIG. 3 is side view of a portion of the vehicle of FIG. 1 showing a connection plate of the vehicle connection system being connected thereto; FIG. 4 is a side view of a portion of the vehicle of FIG. 1 showing a connection plate being connected thereto;

FIG. 5 is a perspective view of the propelling vehicle of FIG. 1 being connected to a connection plate of the vehicle connection system;

FIG. 6 is a front view of the propelling vehicle of FIG. 1 being connected to a connection plate of the vehicle connection system;

FIG. 7 is a side view of a portion of the propelling vehicle of FIG. 1 being connected to a connection plate of the vehicle connection system;

FIG. 8 is a perspective view of the propelling vehicle of FIG. 1 being connected to a connection plate of the vehicle connection system showing locking plates on the propelling vehicle moving towards each other and the connection plate;

FIG. 9 is a front view of the propelling vehicle of FIG. 1 being connected to a connection plate of the vehicle connection system showing locking plates having guides on the propelling vehicle moving towards each other and the connection plate;

FIG. 10 is a rear view of a receiver plate of the vehicle connection system of FIG. 1 showing actuators for the plate and a charging plug;

FIG. 11 is a side view of portion of the propelling vehicle of FIG. 1 being connected to a connection plate of the vehicle connection system when locking plates of the propelling vehicle are moving towards each other and the connection plate;

FIG. 12 is a perspective view of the propelling vehicle of FIG. 1 being connected to a connection plate of the vehicle connection system showing locking plates on the propelling vehicle connected to the connection plate;

FIG. 13 is a front view of the propelling vehicle of FIG. 1 being connected to a connection plate of the vehicle connection system showing locking plates having guides in a close position connected to the connection plate;

FIG. 14 is a side view of portion of the propelling vehicle of FIG. 1 being connected to a connection plate of the vehicle connection system showing locking plates on the propelling vehicle connected to the connection plate;

FIG. 15 is a perspective view of another example of a connection plate of the connection system of FIG. 1 having a charging plug receiver;

FIG. 16 is side view of the propelling vehicle of FIG. 1 connected to a charging receiver and an electrical vehicle charger;

FIG. 17 is a side view of another example of a lead vehicle connected to a propelling vehicle by a vehicle connection system include a charging cable connecting the vehices in accordance with the present invention;

FIG. 18 is a side view of another example of a lead vehicle connected to a propelling vehicle and the propelling vehicle being connected to a trailer by a vehicle connection system in accordance with the present invention; and

FIG. 19 is a progression of views showing a connection of the lead vehicle and propelling vehicle of FIG. 1.

### DETAILED DESCRIPTION OF THE INVENTION:

In accordance with the principles of the present invention, systems and methods for controlling a propulsion vehicle are provided.

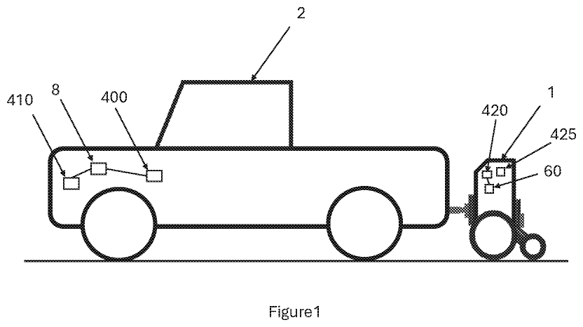

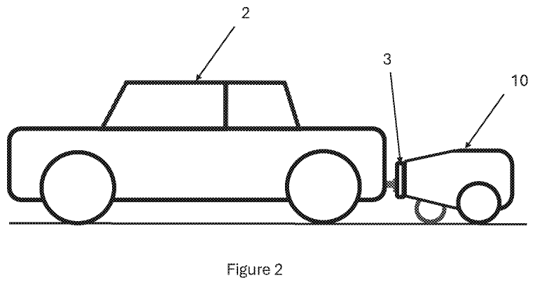

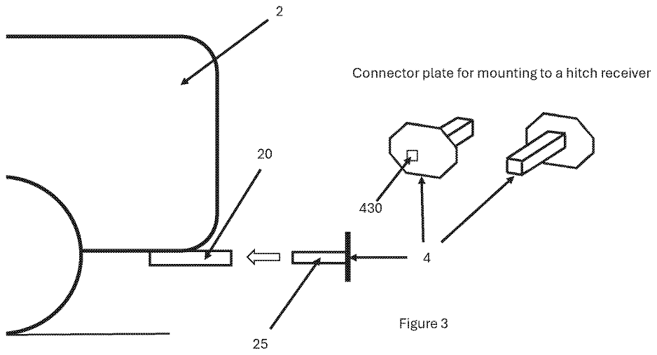

As depicted in FIGS. 1-2, a self-powered, driverless propulsion vehicle 1 may be used to propel a towing position vehicle or lead vehicle 2 and thereby reduce the energy needs of lead vehicle 2.

Lead vehicle 2 may include a driving mechanism or engine 8 for causing movement thereof. Lead vehicle 2 may be an electrically powered vehicle with a regenerative braking system that may recharge a battery (not shown) of the vehicle when the vehicle is braking or slowing. Lead vehicle 2 may include an internal combustion engine powered by fuels such as gasoline or diesel as a sole or supplemental driving engine. Propulsion vehicle 1 may similarly include an internal combustion engine (not shown) and/or an electric motor (not shown) coupled to an electric battery (not shown).

Propulsion vehicle 1 may be configured to provide a force to move or assist in a movement of lead vehicle 2. Propulsion vehicle 1 may be attachable to, or may be configured to provide such a force while contacting but not attached to, lead vehicle 2. A force provided by propulsion vehicle 1 to lead vehicle 2 (when lead vehicle 2 includes an electric motor) may increase a stored battery energy of electric vehicle via a regenerative braking system that normally recharges the battery when the vehicle is braking or slowing. Recharging the battery of an electrically powered lead vehicle (e.g., lead vehicle 2) occurs when the electric lead vehicle is being propelled by the propulsion vehicle (e.g., propulsion vehicle 1) and the regenerative braking system is partially engaged as is often true during normal operation of many electric vehicle types. Recharging of the battery via regenerative braking while under propulsion may require additional propulsion energy from the self-powered propulsion vehicle beyond the energy required to propel both vehicles.

A speed of lead vehicle 2 when pushed or propelled by propulsion vehicle 1 may be controlled via a plug-in or a vehicle integrated speed control and communication system or by the use of an application (e.g., a smartphone or tablet computer application) for controlling a speed of propulsion vehicle 1 and lead vehicle 2, for example, as described in co-owned U.S. Application No. ______, filed on the same day as this application, and titled SYSTEMS AND METHODS FOR CONTROLLING A PROPULSION VEHICLE which is incorporated herein by reference in its entirety.

Lead vehicle 2 may include a lead vehicle controller module 400 for connecting to a vehicle controller 410 of lead vehicle 2 coupled to engine 8 and a propelling controller module 420 in propulsion vehicle 1 coupled to an engine 425 thereof as depicted in FIG. 1, for example. Such engines could be internal combustion engines or electric motors, for example. Such controllers may communicate via Bluetooth and other communication systems as described for lead vehicle controller module 4, propelling controller module 3 and vehicle controller 7 in the co-owned US patent application described above. Vehicle controller 7 may control an internal combustion engine or electric vehicle engine of lead vehicle 2 and propelling controller module 420 may control an internal combustion engine or electric vehicle engine of propulsion vehicle 1.

A propulsion vehicle as described may take a variety of forms and sizes and propel a variety of vehicles (e.g., lead vehicle 2). For example, propulsion vehicle 1 is depicted in FIG. 1, and a second propulsion vehicle 10 is depicted in FIG. 2, connected to lead vehicle 2. Propulsion may otherwise include the components and may function as described for propulsion vehicle 1.

As depicted in FIG. 1, lead vehicle 2 may be attached or connected to propulsion vehicle 1 via a connecting mechanism prior to propulsion vehicle 1 providing a force to lead vehicle 2.

As described above connecting a towed vehicle or trailer is normally a manual process and may require a person to be outside of a tow vehicle (e.g., lead vehicle 2) to help align the tow vehicle with the towed vehicle, and otherwise facilitate such a manual connection. In contrast, lead vehicle 2 may be connected to propulsion vehicle 1 via an automatic connection/docking device 3 as depicted on propulsion vehicle 1 and propulsion vehicle 10 as depicted in FIGS. 1 and 2. Utilizing docking device 3, a trailer hitch connection may be completed without the need of a person to perform the tasks typical of connecting the hitch of a towed vehicle (e.g., propulsion vehicle 1 or propulsion vehicle 10) or trailer to a tow vehicle (e.g., lead vehicle 2) nor to exit the tow vehicle at all to assist with such a connection.

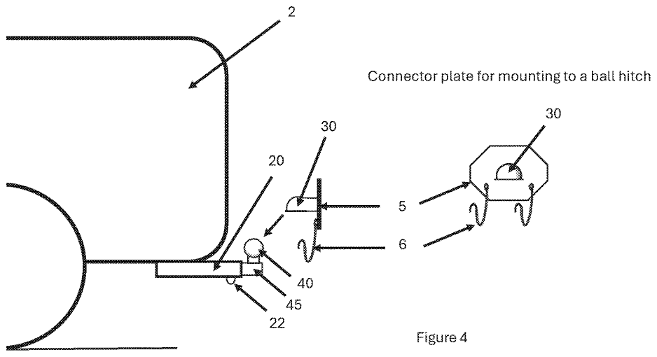

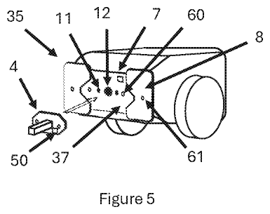

Docking device 3 may include a connector plate 4 connectable to propulsion vehicle 1 and lead vehicle 2 as depicted in FIGS. 3 and 5, for example. Lead vehicle 2 may include a hitch receiver 20 (e.g., a tube hitch receiver with a square cross-section) and plate 4 may include an extending portion 25 configured (e.g., shaped and dimensioned) to be received in receiver 20 and connected via a pin (not shown) extending perpendicular to a direction that extending portion 25 is received in receiver 20 similar to an attachment of a standard hitch and hitch receiver.

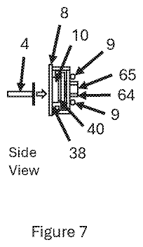

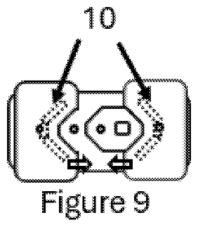

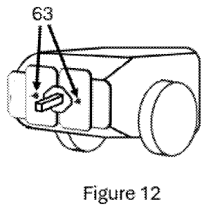

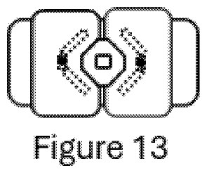

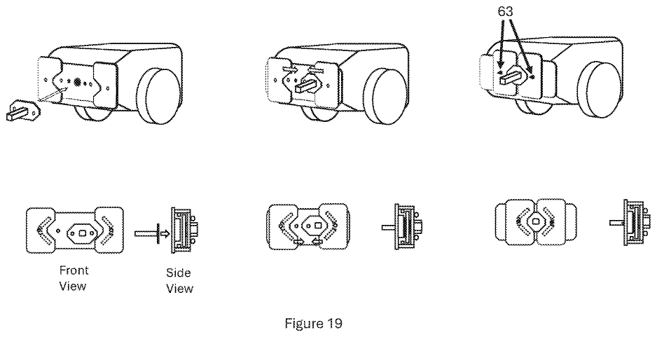

Docking Device 3 may include a receiver connection plate 7 mounted to a front 35 of propulsion Vehicle 1 as depicted in FIGS. 5-13, for example. Connecting lead vehicle 2 and propulsion vehicle 1 may be accomplished by positioning connector plate 4 and receiver connection plate 7 flat against each other and locking them together as described below and as depicted in a progression of views in FIG. 19.

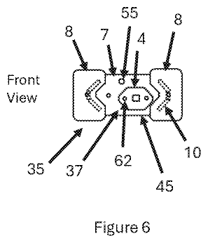

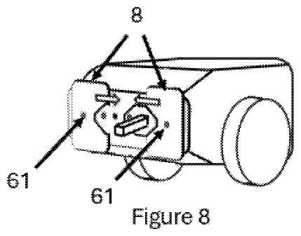

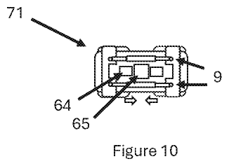

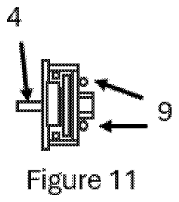

Receiver connection plate 7 may include two slide locking plates 8 which may be positioned at lateral extremities of receiver connection plate 7 in an open most position as depicted in FIG. 5. Locking plates may be connected to a mechanical system 9 depicted in FIG. 10, and which may include linear actuators 18 or hydraulic actuators, cable winch(es) or other commonly used mechanical system capable of simultaneously directing slide locking plates 8 toward or away from each other. Slide locking plates 8 may be positioned away from a surface 37 of receiver connection plate 7 (e.g., in a direction away from a remainder of propulsion vehicle 1) such that a space or gap 40 exists between surface 37 of connection plate and inner surfaces 38 of slide locking plates 8. Gap 40 may exceed a thickness of connector plate 4. Guides 10 may be positioned within gap 40 bounded by slide locking plates 8 (e.g., inner surface 38) and surface 37 and may direct connector plate 4 to a central portion 45 on receiver plate 37 as slide locking plates 8 are moved toward each other and central portion 45 of the receiver connection plate 7 as depicted in FIG. 6. For example, guides 10 may be connected to inner surfaces 38 of locking plates 8 and may be configured (e.g., shaped and dimensioned) to engage connector plate 4 to move connector plate 4 when locking plates move toward each other (FIGS. 8-10). In this way connector plate 4 may be moved to central portion 45 (e.g., by a force placed on connector plate 4 by guides 10). Locking plates 8 may be moved in this way (e.g., via mechanical system 9) to a fully closed position as depicted in FIGS. 11-13 and connector plate 4 may thus be aligned to a center (e.g., central portion 45) of receiver plate 7.

Pins 63 may be mounted on a rear side 71 of receiver plate 7 and may extend (e.g., automatically controlled by actuators 64 and a controller) from behind receiver plate 7 through openings 60 in receiver plate 7, openings 61 in locking plates 8, and openings 62 in connector plate so as to lock slide locking plates 8 and connector plate 4 in position relative to each other. When slide locking plates 8 and connector plate 4 are locked in such a way, actuators 64 may retract and clip may be utilized to hold pins 63 in place. Such pins may be retracted by actuators 64 to allow movement between locking plates 8 and receiver plate 7. Alternatively, pins 63 may be biased by a spring such that pins 63 retract via such a spring without action by actuator 64. Further, slide locking plates 8 may be connected to and biased by springs such that when pins retract slide locking plates 8 open and the connector plate 4 may be removed. The pins may be hitch receiver pins or similar pins for connecting tractors or trailers (e.g., a farm trailer hitch to a tractor).

Locking plates 8 may be movably connected to receiver connection plate 7 and receiver connection plate may be connected to propulsion vehicle 1, such that when locking plates are closest to each other and closed about connector plate 4, connector plate may remain connected to receiver connection plate 7 (and thus lead vehicle 2 to propulsion vehicle 1). In this connected position, propulsion vehicle 1 may apply a force to lead vehicle 2 to move, and charge a battery of, lead vehicle 2 without the vehicles being separated from each other during such an application of force and movement of the vehicles.

A positioning of lead vehicle 2 and/or propulsion vehicle 1 to allow connector plate 4 to dock with the receiver plate 7 may be accomplished by autonomous or other vehicle control systems in propulsion vehicle 1, which may approach lead vehicle 2 from a rear thereof. Connector plate 4 may also include a light projector 50 for a laser or other light to allow a projection of a laser, light or other wireless pattern to assist sensors 55 of propulsion vehicle 1 to locate and align connector plate 4 with receiver plate 7. Such sensors (e.g., sensors 55) may be cameras, LIDAR or other sensors on receiver plate 7 or elsewhere on propulsion vehicle 1 to be employed by an autonomous control system 60 (FIG. 1) of propulsion vehicle 1 to position propulsion vehicle 1 to allow a connection of connector plate 4 and receiver plate 7. System 60 may be coupled to sensors 55 and light project 50, along with propelling controller module 420, such that system 60 and propelling controller module 420 coupled to motor 425 may control a movement of propulsion vehicle 1 to connect connector plate 4 and receiver plate 7 to each other. Such a connection may allow propulsion vehicle 1 to provide a force to lead vehicle 2 when desired, such as to push lead vehicle 2 to move lead vehicle 2 and/or allow a regenerative braking system of lead vehicle 2 to charge a battery thereof when lead vehicle 2 is an electric vehicle with such a regenerative braking system, for example.

In another example, connector plate 4 may include an infrared or other wireless transmitter 430 and receiver 11 mounted to the lead vehicle hitch connector plate as a supplement to or in place of light projector 50. Such infrared or other wireless signals primarily originate from transmitter 430 (FIG. 3) (e.g., similar to transmitter 7 in the co-owned patent application indicated above) coupled to propelling control module 420 and are received by signal receiver 11 (FIG. 5) mounted in receiver plate 7 as a supplement to or in place of sensors 55 and may be further transmitted to propulsion vehicle controller module 420. When the connector plate is centrally aligned (e.g., on central portion 45) on receiver plate 7, openings in connector plate 4 and the receiver plate 7 also align allowing infrared or other wireless signals to be transmitted directly between the openings while limiting the potential for light, radio or other interference of the signals.

In another example, Docking Device 3 may include a vertical alignment or lift system that provides an ability to raise or lower receiver plate 7 as needed to facilitate a connection of connector plate 4 and receiver plate 7 Such a lift system may allow a movement of receiver plate 7 relative to a remainder of propulsion vehicle 1 or could be a part of a suspension system propulsion vehicle 1 such that an entirety of propulsion vehicle 1 is lifted or lowered to allow a connection as described, instead of adjusting a vertical position of only receiver plate 7.

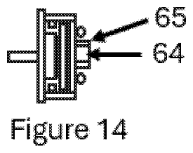

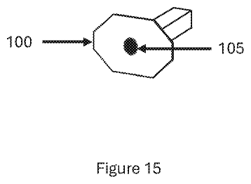

Receiver plate 7 may include a plug opening 12 (FIG. 5) to allow a charging plug to pass through receiver plate 7 (e.g., extending from propulsion vehicle 1) and into a plug receiver 105 of a second connector plate 100 shown in FIG. 15. For example, second connector plate 100 may be identical to plate 4 except for such a plug receiver (e.g., plug receiver 105) which may connect to a charger plug of an electric vehicle charger for example. An alignment and connection of connector plate 100 and the receiver plate 7 may bring the charging plug (e.g., extending from propulsion vehicle 1 via a plug actuator 65 depicted in FIGS. 10 and 14) into alignment with plug opening 12 to allow the charging plug (e.g., from propulsion vehicle 1) to pass therethrough to connect to plug receiver 105 via an actuator in propulsion vehicle 1. This action may allow propulsion vehicle 1 to automatically connect to an electrical vehicle charging station (e.g., by extending the charging plug through opening 12) for electrically charging a battery of propulsion vehicle as described below or alternatively for propulsion vehicle 1 to provide power to another electric vehicle (V2V), the electrical grid (V2G) or other electric load (V2X).

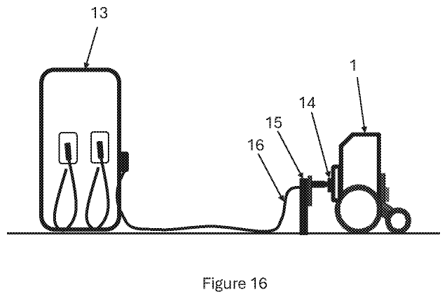

For example, propulsion vehicle 1 may autonomously dock (e.g., via propelling control module 420), )and plug into an electric vehicle charging station 13 via a charger plug receiver port (not shown), similar to plug receiver 105, located in a charging station connector plate 14 identical to connector plate 100 described above as mountable in hitch receiver 20, but in this instance charging station connector plate 14 may be mounted to a post 15 or other structure located at an electric vehicle charging station as depicted in FIG. 16. The charger plug receiver port (not shown) mounted in connector plate 14 may be connected to the charging station or power source via a power cord 16. The power cord may be wired into the charging station or power source to provide power for charging propulsion vehicle 1, for example. Additionally, many existing charging stations have a charger plug receiver port for holding a charger plug when not in use which is not electrically connected to anything. In an example, the charger plug receiver port may wired from the connector plate on the post (or other structure) to the electrically providing portion of the charge in place of the plug holder port. The existing charger cord may serve to be plugged into electric vehicle for charging such vehicle normally, while also allowing the same charger cord, when not in use charging an electric vehicle, to provide a direct electrical connection to the charger plug receiver port mounted in connector plate 14 to allow propulsion vehicle 1 to charge whenever the charging station is not in use for directly charging an electric vehicle parked at the station.

In an example, propulsion vehicle 1 may also provide on-demand, autonomous portable emergency backup power, on-site remote powering of devices (V2X) or electrical grid support (V2G). To give several examples, a connector plate (e.g., similar to connector plate 100 or connector plate 14) may be mounted on a building, work site equipment, an on-site battery energy storage unit or a power pole. In each of these examples, a powering cord or fixed wiring may lead from the electrical load to a charger plug receiver in the connector plate such that propulsion vehicle 1 may make an electrical connection to the load by autonomously plugging into the connector plate similar to charging station connector plate 14 described above.

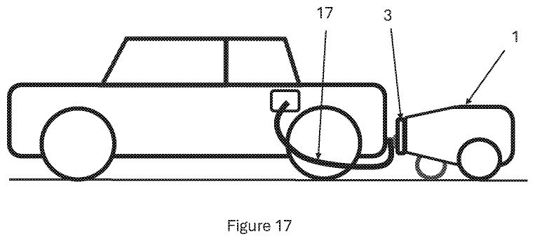

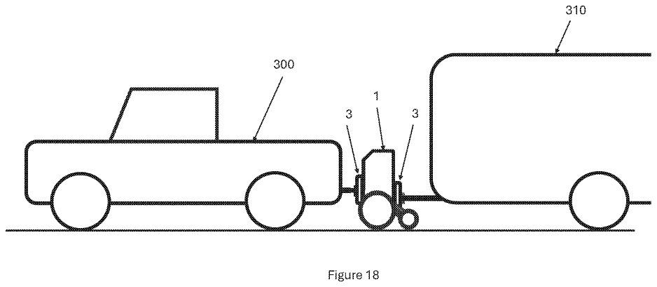

Further, propulsion vehicle 1, via docking device 3 may also serve to directly charge an electric vehicle using known vehicle to vehicle (V2V) charging systems. In this instance, the charger plug receiver port (e.g., similar to receiver port 105) mounted in the lead vehicle connector plate, itself mounted in a standard hitch receiver, may provide a wired connection 18 which may be plugged into the charging port of an existing electric vehicle as depicted in FIG. 17. Once such a connection has been made, the driver may leave the parked electric vehicle unattended such that a propulsion vehicle (e.g., propulsion vehicle 1) may be delivered to the location of the vehicle and may autonomously dock with the connector plate on the electric vehicle, plug into the charger plug receiver port in the connection plate and begin charging the electric vehicle. Upon completion of the charging service, the propulsion vehicle may also autonomously disconnect from the connector plate of the electric vehicle and then remove to a nearby location to await pickup by another vehicle. In the instance in which an electric vehicle has no hitch receiver, the connector plate may instead be fastened to the electric vehicle by means of a magnet or other method of fastening. Additionally, the cord providing a means of plugging into the charger port, may also be integrated into the vehicle body and charging system. In such an instance, the driver may need to take no action to allow the propulsion vehicle to charge the electric vehicle other than to place a command for a propulsion vehicle (e.g., propulsion vehicle 1) to be delivered to provide a charge. A charger cord and charging connection integrated into the electric vehicle may also provide a means of directly charging a vehicle while in motion, if the vehicle battery, motor and control systems can be configured to allow charging to occur while in motion.

In another example depicted in FIG., 18, a propulsion vehicle (e.g., propulsion vehicle 1) may serve as a towing assist unit. In this application the propulsion vehicle may be placed between a tow vehicle 300 and a towed trailer 310. The connection between tow vehicle 300 and propulsion vehicle 1 may be provided by instances of Docking Device 3 as described previously. Use of Docking Device 3 between tow vehicle 300 and propulsion vehicle 1 may allow a closer connection and reduced overall combined length of the tow vehicle 300, propulsion vehicle 1 and towed trailer 310 than might otherwise occur were a standard trailer connection used between the tow vehicle 300 and propulsion vehicle 1. Additionally, use of Docking Device 3 may provide a rigid connection between tow vehicle 300 and propulsion vehicle 1 such that additional space for articulation of the connection is not needed. In such an instance, the propulsion vehicle 1 may have means by which all wheels may articulate in a range of directions allowing tow vehicle 300 and propulsion vehicle 1 to turn in unison. The connections between propulsion vehicle 1 and the towed trailer 310 may also be provided by instances of Docking Device 3 as described previously or may use a standard towing connection such as a ball hitch.

Further, the above described connection between a lead vehicle (lead vehicle 2) and a propulsion vehicle (e.g., propulsion vehicle 1) may be done using various connection mechanisms that allow such a system propulsion vehicle (e.g., propulsion vehicle 1) to apply a force and move a lead vehicle (lead vehicle 3) and connect the vehicles to each other to allow such a force and movement to occur. The connection between vehicles may be magnetic devices either in a connector plate (e.g., plate 4) and/or a receiver plate (e.g., plate 7) for securing the connector plate and receiver plate together. Further, in addition to an automatic connection being via a plate received between locking plates as described above, such a connection could be via a bar or post or similar common structures instead of a plate for the connection device and a corresponding clamping/locking mechanism.

In another example a connector plate 5 connectable to propulsion vehicle 1 may include a ball receiver 30 for connection to a ball 40 of a ball hitch 45 connected to receiver 20 as depicted in FIG. 4. Ball receiver 30 may include a locking mechanism as in a standard hitch ball receiver to retain ball 40 therein. Also, safety chains or cables 6 may remain connected to connecting loops 22 of receiver 20 of lead vehicle 2 and connector plate 5, irrespective of whether propulsion vehicle 1 is connected or not, which may satisfy some state towing requirements.

The plates described above (e.g., connection plate 4, receiver connection plate 7, connector plate 5, connector plate 100 or connector plate 14) may be made of steel. The connector plates (e.g., connection plate 4, connector plate 5, connector plate 100 or connector plate 14) described for connecting to a receiver plate (e.g., receiver connection plate 7), charger or other receiver may be formed 8 inches wide and 5 inches tall, for example. A receiver plate (e.g., receiver plate 7) may be 2 feet by one foot, or fourteen inches by ten inches, for example. The described plates may be made of any material and dimensions to allow the connections described above to be made and maintained during the uses described.

The controllers described (e.g., a lead vehicle controller module 400, vehicle controller 410, propelling controller module 420, autonomous control system 60 may be separate controllers as described above or could be portion of a single controller (with the functions of one or more of the controllers) which could be any type of computing unit capable of performing the steps described from a programmed set of instructions.

While several aspects of the present invention have been described and depicted herein, alternative aspects may be effected by those skilled in the art to accomplish the same objectives. Accordingly, it is intended to cover all such alternative aspects as fall within the true spirit and scope of the invention.

It is to be understood that the above description is intended to be illustrative, and not restrictive. Numerous changes and modifications may be made herein by one of ordinary skill in the art without departing from the general spirit and scope of the disclosure as defined by the following claims and the equivalents thereof. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While the present disclosure has been described in detail in connection with only a limited number of embodiments, it should be readily understood that the present disclosure is not limited to such disclosed embodiments. Rather, the invention can be modified to incorporate any number of variations, alterations, substitutions or equivalent arrangements not heretofore described, but which are commensurate with the spirit and scope of the present disclosure. Additionally, while various embodiments of the present disclosure have been described, it is to be understood that aspects of the disclosure may include only some of the described embodiments.

1. A vehicle connection system comprising:
a receiver plate connectable to a first vehicle and a plurality of locking plates movably connected to the receiver plate;
the plurality of locking plates comprising inner surfaces spaced from the receiver plate by a gap;
a connecting plate connectable to a second vehicle and having a thickness less than a dimension of the gap such that the connecting plate is receivable in the gap when the connecting plate contacts the receiver plate;
the plurality of locking plates movable toward each other to contact an extending portion of the connecting plate to connect the receiver plate to the connecting plate to the receiver plate to connect the first vehicle to the second vehicle when the receiver plate is connected to the first vehicle and the connecting plate is connected to the second vehicle.

2. The system of claim 1 wherein the first vehicle is an autonomous propulsion vehicle and the second vehicle is an electrical vehicle having a charge regeneration system, and the first vehicle is configured to apply a force to the second vehicle to provide a charge to a battery of the second vehicle when the first vehicle is connected to the second vehicle by the connecting plate connecting to the receiver plate.

3. The system of claim 1 wherein the second vehicle comprises a hitch receiver and the extending portion of the connecting plate is configured to be received in and connect to the hitch receiver.

4. The system of claim 1 wherein the plurality of locking plates comprise a plurality of guides configured to contact the extending portion of the connecting plate to move the connecting plate to a central portion of the receiver plate when the locking plates move toward each other.

5. The system of claim 4 wherein the plurality of guides is attached to the inner surfaces of the locking plates.

6. The system of claim 1 wherein the receiver plate comprises an opening for receiving a charger plug to allow the first vehicle to electrically connect to an electric vehicle charger to charge a battery of the first vehicle.

7. The system of claim 6 wherein the charger plug is automatically extendable through the opening to connect to the electric vehicle charger.

8. The system of claim 1 wherein the connector plate comprises a signal transmitter coupled to a controller of the second vehicle and the receiver plate comprises a signal receiver coupled to a controller of the first vehicle to allow the first vehicle and the second vehicle to move relative to each other to facilitate a connection of the connection plate to the receiver plate.

9. A method for use in in propelling a vehicle, comprising:
contacting a connecting plate connected to a vehicle with a receiver plate connected to a second vehicle;
moving a plurality of locking plates movably connected to the receiver plate from an outer position toward a center of the receiver plate and toward each other to contact an extending portion of the connecting plate to connect the first vehicle to the second vehicle.

10. The method of claim 9 wherein the moving the locking plates comprises guides of the locking plates moving toward the center portion to contact the extending portion to move the connecting plate toward the center portion.

11. The method of claim 9 wherein the locking plates are spaced from the receiver plate by a gap and the guides and connecting plate are received in the gap.

12. The method of claim 9 further comprising the first vehicle moving toward the second vehicle autonomously controlled by a controller to cause the connecting plate to contact the receiver plate and the locking plates moving toward each other in response to a second controller receiving an indication from the controller or a sensor that the connecting plate contacted the receiver plate.

13. The method of claim 9 wherein the first vehicle is an autonomous propulsion vehicle and the second vehicle is an electrical vehicle having a charge regeneration system, and the first vehicle o applies a force to the second vehicle to provide a charge to a battery of the second vehicle when the first vehicle is connected to the second vehicle by the connecting plate connecting to the receiver plate.

14. The method of claim 9 wherein the second vehicle comprises a hitch receiver and further comprising receiving the extending portion of the connecting plate in the hitch receiver and connecting the extending portion to the hitch receiver.

15. The method of claim 1 further comprising extending a charging plug from the first vehicle through an opening in the receiver plate to electrically connect the first vehicle to an electric vehicle charger to charge a battery of the first vehicle.

16. The method of claim 15 wherein the second vehicle is autonomously moved to the electric vehicle charger and the plug is automatically extended through the opening to connect to the electric vehicle charger.

17. The method of claim 9 wherein the connector plate comprises a signal transmitter coupled to a controller of the second vehicle and the receiver plate comprises a signal receiver coupled to a controller of the first vehicle and further comprising the second vehicle sending a message to the first vehicle via the transmitter and the receiver to facilitate a connection of the connection plate to the receiver plate.
